(19) United States
(12) Patent Application Publication
(10) Pub. No.: US 2012/0000395 A1
(43) Pub. Date: Jan. 5, 2012

(54) Method for producing photocatalytically active clinker

(75) Inventors: Shreesh Anant Khadilkar, Maharashtra (IN); Manish Vasant Karandikar, Maharashtra (IN); Pradeep Gopal Lele, Maharashtra (IN)

(73) Assignee: Holcim Technology Ltd., Rapperswil-Jona (CH)

(21) Appl. No.: 13/140,592

(22) PCT Filed: Dec. 15, 2009
(86) PCT No.: PCT/IB2009/007783

§ 371 Date: Jul. 26, 2011

(30) Foreign Application Priority Data
Dec. 17, 2008 (AT) A 1888/208

(51) Int. Cl. C04B 7/32; C04B 7/02

(52) U.S. Cl. 106/693; 106/733

(57) ABSTRACT

In a method for producing photocatalytically active clinker, TiO₂-containing materials are reacted to calcium titanates, particularly CaTiO₃, with clinker raw meal or clinker raw mix.

The invention relates to a method for producing photo-catalytically active clinker.

Photocatalysis in this context means reactions in which a catalyst is brought into an excited state by the exposure to light of a suitable wavelength, which state enables the catalysis of various degradation reactions of different organic molecules. The catalyst in such reactions returns to the initial state and can be reexcited by light.

A number of construction materials in which the photocatalytic phenomenon is utilized are already known, with titanium dioxide in the anatase form being used in the first place. European Patent EP 1 535 886 discloses a hydraulic binder containing titanium dioxide together with additives and water in the form of photocatalytic particles, at least 5% by weight of the titanium dioxide particles having anatase structure. In the hydraulic binder according to EP 1 535 886, anatase portions of the titanium dioxide phase of up to 70% are, moreover, provided, the balance of the titanium dioxide primarily comprising rutile. In that hydraulic binder, the share of the anatase form in the total amount of the present titanium dioxide is thus extremely important for its photocatalytic action such that the selection and sourcing of suitable titanium dioxide is problematic.

It is, therefore, the object of the present invention to provide a method that enables the production of photocatalytically active clinker, and hence photocatalytically active cement, in which titanium dioxide can be used irrespectively of its origin and anatase content. To solve this object, the method according to the invention essentially consists in that TiO₂-containing materials are reacted to calcium titanates, particularly CaTiO₃, with clinker raw meal or clinker raw mix. The method according to the invention enables TiO₂-containing materials of any origin to be directly introduced into the clinker during the clinker production process and reacted to the photocatalytically active species referred to as calcium titanate or CaTiO₃. These compounds, besides CaTiO₃, also comprise other compounds such as CaTiO₄, Ca₃Fe₂TiO₈, CaTi₄O₉, Ca₂Ti₅O₁₂, Ca₄Ti₃O₁₀, CaTi₂O₄(OH)₂, NaK₂Ca₂TiSi₇O₁₉(OH), CaTiSiO₅, BaCaTiO₄, Ca₃Fe₂TiO₈, Ca₂TiO₄O₁₂. 4H₂O, Mg₂TiO₄O₁₂·4H₂O, Fe₂TiO₄O₁₂·4H₂O, Al₂TiO₄O₁₂·4H₂O, Ca₃Fe₃O₁₂, Ca₃Ti₃O₁₂, Ca₃(Ti₂Si)₃O₁₂, Ca₃Fe₂TiO₄(OH)₈, MgAl₂TiO₃O₁₀, α-Al₂TiO₅, Al₂TiO₅, Mg₂Al₆Ti₇O₂₅ and BaTi₄Al₂O₁₂. All of these compounds are photocatalytically active and improve the photocatalytic activity of the clinker and the cement, respectively, and they are formed depending on the availability of oxides like Al₂O₃, Fe₂O₃, BaO, SrO, Mn₂O₃, SiO₂, Na₂O, K₂O or the like.

The method according to the invention is advantageously further developed to the effect that the TiO₂-containing materials are charged into, and burned in, a rotary kiln together with the clinker raw mix, which will be of particular advantage if the titanium dioxide is present in powder form, thus enabling easy mixing with the raw meal for the production of clinker. Alternatively, it may, however, preferably be provided that the TiO₂-containing materials and the clinker raw mix are separately charged into the rotary kiln, and reacted and burned together in the rotary kiln. Such a process control will be advantageous if the titanium dioxide is present in the form of a suspension such that mixing with the calcined raw meal appears to be infeasible. The moist or wet TiO₂-containing materials in this case can be introduced into the rotary kiln by the aid of known injection devices, thus causing thorough mixing of the TiO₂-containing materials with the raw meal only in the rotary kiln during the conversion of TiO₂ to CaTiO₃ or any of the above-mentioned compounds.

The method according to the present invention is advantageously further developed such that the combustion occurs at temperatures above 1250° C., preferably at 1350° C., and in a particularly preferred manner at 1450° C. It was experimentally found that the formation of CaTiO₃ from Cad and TiO₂ started at temperatures above 1250° C., the complete reaction of the used titanium dioxide with the excess CaO to CaTiO₃ having been observed at combustion temperatures of 1450° C.

In order to provide a sufficient photocatalytic action of the cement made with the clinker produced by the method according to the invention, a suitable amount of CaTiO₃ must be present in the clinker, wherein an overdose of CaTiO₃ would jeopardize the physical integrity of the cement. The method according to the present invention is, therefore, preferably further developed to the effect that the TiO₂-containing materials are added to the clinker raw mix in amounts producing a TiO₂ content of 2% by weight to 5% by weight and, in particular, 3% by weight, from which CaTiO₃ portions of approximately 4% by weight to 10% by weight will result in the clinker. If required, the portion of used titanium dioxide may, however, also be chosen to be higher.

As already mentioned in the beginning, the method according to the invention enables the use of TiO₂-containing materials of the most different origins, and it is preferably provided in the context of the method according to the present invention that waste substances such as dye sludge, waste dye, kiln ashes, synthetic materials and/or consumed TiO₂ catalyst are used as TiO₂-containing materials. Such starting materials are available on the market at extremely low cost and even involve disposal problems in some industrial branches, so that the present invention allows for the production of photocatalytic clinker in an extremely cost-effective manner. When using dye sludge, waste dye and synthetic materials, the solvent residues, or residues of other organic compounds, possibly still contained in these materials may even provide additional benefits to the effect that the compounds present besides TiO₂ may serve as secondary fuels in the clinker process.

The method according to the invention is suitable for the production of photocatalytically active clinker based on already known clinker compositions, said method advantageously being further developed to the effect that a raw mix for calcium sulfoaluminate clinker is used as clinker raw mix. The CaTiO₃ formed by the method according to the invention will not adversely affect the setting and strength characteristics of the finished clinker, thus enabling the clinker produced by the method according to the invention to be processed in a known manner. Alternatively, it may advantageously proceeded such that a raw mix for Portland cement clinker is used as clinker raw mix.

According to a further object of the present invention, photo-catalytically active clinker is provided, which is characterized in that the photocatalytically active phase comprises calcium titanates, particularly CaTiO₃. The group of calcium titanates comprises the above-mentioned compounds. As described in the beginning, titanium dioxide and, in particular, titanium dioxide in the anatase form has so far been used for photocatalytically active clinker or photocatalytically active cement. It has now turned out in a surprising manner that also CaTiO₃ possesses outstanding photocatalytic properties, wherein CaTiO₃ can be directly produced during the clinker process in an extremely cost-effective manner by the above-identified method. For the production of CaTiO₃ it may alternatively also be proceeded in a manner that CaTiO₃-containing materials and, in particular, materials indicated above as being preferred for carrying out the method according to the invention are reacted with CaO at temperatures above 1250° C. and, in particular, at 1450° C.

In order to ensure both a sufficient photocatalytic activity and the required strength characteristics in the clinker according to the invention, the clinker according to the invention is advantageously further developed such that CaTiO₃ is contained in amounts of 2% by weight to 10% by weight and, in particular, in amounts of 6% by weight.

1. A method for producing photocatalytically active clinker, characterized in that TiO₂-containing materials are reacted to calcium titanates, particularly CaTiO₃, with clinker raw meal or clinker raw mix.

2. A method according to claim 1, characterized in that the TiO₂-containing materials are charged into, and burned in, a rotary kiln together with the clinker raw mix.

3. A method according to claim 1, characterized in that the TiO₂-containing materials and the clinker raw mix are separately charged into the rotary kiln, and reacted and burned together in the rotary kiln.

4. A method according to claim 2, characterized in that the combustion occurs at temperatures above 1250° C.

5. A method according to claim 1 characterized in that the TiO₂-containing materials are added to the clinker raw mix in amounts producing a TiO₂ content of 2% by weight to 5% by weight.

6. A method according to claim 1, characterized in that waste substances such as dye sludge, waste dye, kiln ashes, synthetic materials and/or consumed TiO₂ catalyst are used as TiO₂-containing materials.

7. A method according to claim 1, characterized in that a raw mix for calcium sulfoaluminate clinker is used as clinker raw mix.

8. A method according to claim 1, characterized in that a raw mix for Portland cement clinker is used as clinker raw mix.

9. A photocatalytically active clinker, characterized in that the photocatalytically active phase comprises calcium titanates.

10. A photocatalytically active clinker, characterized in that CaTiO₃ is contained in amounts of 2% by weight to 10% by weight.

11. A method according to claim 2, characterized in that the combustion occurs at temperatures above 1350° C.

12. A method according to claim 2, characterized in that the combustion occurs at temperatures above 1450° C.

13. A method according to claim 1, characterized in that the TiO₂-containing materials are added to the clinker raw mix in amounts producing a TiO₂ content of 3% by weight.

14. A photocatalytically active clinker, characterized in that the photocatalytically active phase comprises CaTiO₃.

15. A photocatalytically active clinker, characterized in that CaTiO₃ is present in amount of 6% by weight.
